(19) United States
(12) Patent Application Publication
(10) Pub. No.: US 2006/0101447 A1
(43) Pub. Date: May 11, 2006

(54) Methods, systems, and computer program products for performing per-event device synchronization

(76) Inventor: Robert Koch, Norcross, GA (US)

Correspondence Address: Philmore H. Colburn II, Cantor Colburn LLP, 55 Griffin Road South, Bloomfield, CT, 06002, US

(21) Appl. No.: 10/958,814

(22) Filed: Oct. 5, 2004

(51) Int. Cl. G06F 9/44

(52) U.S. Cl. 717/168

(57) ABSTRACT

Exemplary embodiments relate to methods, systems, and computer program products for performing per-event device synchronization activities. The method includes initiating a synchronization operation in response to an entry of event information in an information management application executing on a device. The device is associated with at least one other device, which is executing another information management application. The method also includes assigning a unique identifier to the event information and generating an event message. The event message includes the unique identifier, the event information, and a destination address associated with the other device. The method further includes transmitting the event message to the destination address. Upon receiving the event message, the other device updates the other information management application with the event information via the unique identifier resulting in per-event synchronization of the device and the other device.

### BACKGROUND OF THE INVENTION

Exemplary embodiments of the invention relate generally to information management, and more particularly, to methods, systems, and computer program products for performing per-event device synchronization activities over a network.

Information management (IM) applications, or personal information manager (PIM) applications, provide a variety of organizational capabilities, such as managing contact information, to-do lists and reminders, and appointment calendars. Many individuals who rely on these applications often use them on more than one device. For example, an individual may have an IM application executing on a work computer at the individual's place of employment and also on a mobile computing device (e.g., personal digital assistant, laptop, wireless telephone, etc.). While away from the office, the individual may schedule appointments, set reminders, or add a contact to the mobile computing device. Upon returning to the office, the individual executes a synchronization operation that updates all of the activities conducted on both the work computer and the mobile computing device since the last synchronization operation so that each device has the most current, up-to-date information. Synchronization is generally performed by placing the mobile computing device in a cradle, connecting the cradle to the work computer via, e.g., a universal serial bus (USB) cable, and executing the synchronization operation via software resident on either device. The synchronization process generally involves comparing all of the information stored in the IM application of the mobile computing device with all of the information entered in the IM application on the work computer. Any updates previously made on one device but not the other is then copied to the other device, and if there is a conflict, the most current, up-to-date information is selected for the update during synchronization.

One drawback to this type of synchronization is that at any point in time, the information contained on these devices may not be current since many entries may be made in an IM application at either device before a synchronization operation is initiated. Another drawback is that the synchronization process itself involves examining all of the entries in an IM application or folder to determine which entries have been changed, deleted, or are newly added, which can be wasteful of computer resources. A further drawback is that both devices to be synchronized need to be co-located in the same physical area before a synchronization operation may be performed.

What is needed, therefore, is a way to perform synchronization of these devices in real-time or near real-time, without the need to examine all of the data in the information management application or folders of the devices to be synchronized and without the need for the devices to be co-located.

### SUMMARY OF THE INVENTION

Exemplary embodiments of the invention relate to methods, systems, and computer program products for managing per-event synchronization activities over a communications network. Methods include initiating a synchronization operation in response to an entry of event information in an information management application executing on a device. The device is associated with another device, which is executing another information management application. The method also includes assigning a unique identifier to the event information and generating an event message. The event message includes the unique identifier, the event information, and a destination address associated with the other device. The method further includes transmitting the event message to the destination address. Upon receiving the event message, the other device updates the other information management application with the event information via the unique identifier resulting in a per-event synchronization of the device and the other device for that specific data update.

Other embodiments include methods for performing per-event device synchronization. The method includes receiving an event message at a device, the event message including event information entered in an information management application executing on another device. The method also includes prompting a user of the device to accept or reject the event information, receiving a response to the prompting, generating an acceptance message or decline message in response to the receiving, and transmitting the acceptance message or decline message to the other device. The other device updates the information management application with the event information to reflect the acceptance message or decline message resulting in a per-event synchronization of the device and the other device.

Exemplary embodiments further include an apparatus for managing per-event device synchronization over a communications network. The apparatus includes a processor, a memory, and an information management application executing on the processor. The information management application receives an entry of event information and stores the event information in the memory. The apparatus also includes a per-event synchronization application executing on the processor. The per-event synchronization application is in communication with the information management application. In response to receiving the entry of event information, the per-event synchronization application initiates a synchronization operation, assigns a unique identifier to the event information, and generates an event message. The event message includes the unique identifier, the event information, and a destination address associated with a device. The apparatus also includes an email application executing on the processor. The email application is in communication with the per-event synchronization application. The email application transmits the event message to the destination address over a network.

Exemplary embodiments further include an apparatus for managing per-event device synchronization. The apparatus includes a processor, a memory, and an information management application executing on the processor. The information management application receives an event message including event information. The event information is entered in an information management application executing on a device. The apparatus also includes a per-event synchronization application executing on the processor. The per-event synchronization application is in communication with the information management application. In response to receiving an event message, the per-event synchronization application prompts a user to accept or reject the event information, receives a response to the prompts, and generates an acceptance message or decline message in response to receiving the response. The apparatus also includes an email application executing on the processor. The email application is in communication with the per-event synchronization application. The email application transmits the event message to the destination address over a network.

Exemplary embodiments also include computer program products encoded with machine-readable program code for providing per-event synchronization activities over a communications network. The program code includes instructions for causing a host system to receive an event message at a device, the event message including event information entered in an information management application executing on another device. The host system also prompts a user of the device to accept or reject the event information, receives a response to the prompting, generates an acceptance message or decline message in response to the receipt, and transmits the acceptance message or decline message to the other device. The other device updates the information management application with the event information to reflect the acceptance message or decline message resulting in a per-event synchronization of the device and the other device.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the per-event synchronization system may be implemented in exemplary embodiments;

FIG. 2 is a flow diagram of a process for implementing remotely-initiated event synchronization in exemplary embodiments; and

FIG. 3 is a flow diagram of a process for implementing remotely-received event synchronization in exemplary embodiments.

### DETAILED DESCRIPTION OF EXEMPLARY EMBODIMENTS OF THE INVENTION

According to exemplary embodiments, the per-event synchronization system enables synchronization of entries made in an information management application on a per-event basis. The synchronization may occur at or near the time each of the entries are made so that the devices executing the information management applications are updated in real time or near real time enabling a user to maintain the most up-to-date information at any given time. Because the synchronization occurs on a per-event basis, small amounts of information are easily and instantly transferred between the devices executing the information management applications, and only the information relating to the event itself is processed, thereby reducing the time and amount of resources otherwise required to analyze the all of the event data in the devices. The synchronization process does not require that the devices be co-located, so these devices can be synchronized at any time, whether or not they are co-located.

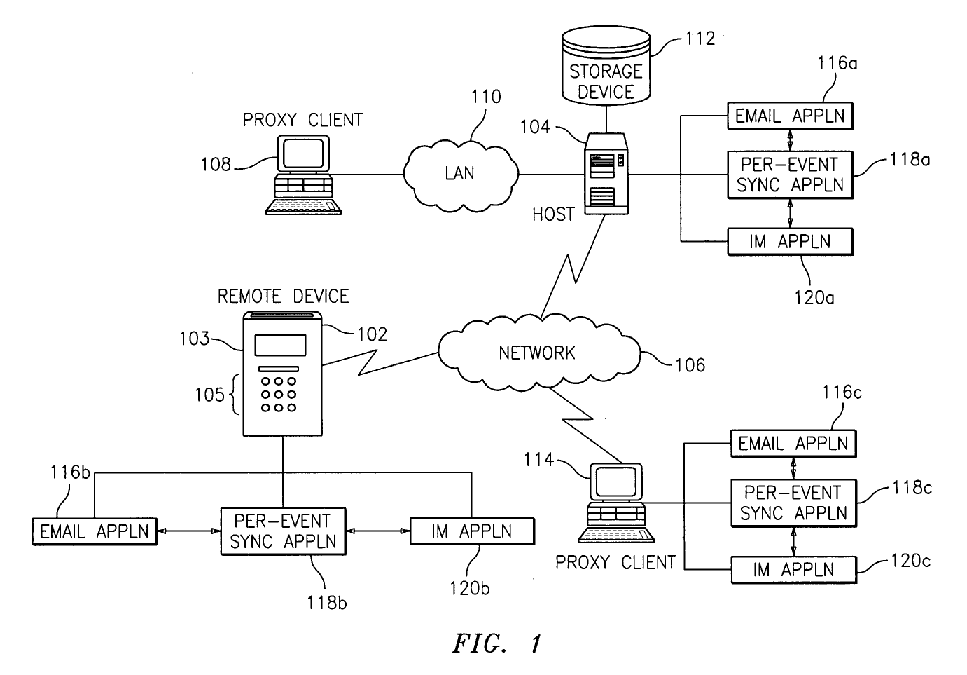

Referring now to FIG. 1, a block diagram of an exemplary system for implementing the per-event synchronization system is generally shown. The exemplary system of FIG. 1 includes a remote device 102 in communication with a host system server 104 via network 106. Remote device 102 may be a portable or handheld computer processing device (e.g., handheld computer, personal digital assistant (PDA), processor-enabled wireless telephone, laptop, or other similar device). The device 102 may include memory for storing items such as voice messages, text messages, pictures, and personal information, among others, and may communicate via a cell tower and mobile switching center (not shown), which, in turn, may communicate with other networks via a central office (not shown). In exemplary embodiments, remote device 102 comprises a wireless computing device with networking capability such as a web browser and an Internet Service Provider subscription for allowing remote device 102 to communicate with other networked devices in the system of FIG. 1.

Remote device 102 includes a display 103 and input controls 105 (e.g., buttons, mouse, scroll, etc.). Remote device 102 further includes memory for storing information such as text files, messages, images, sound files, as well as IM events. Remote device 102 may include a user interface that enables a user to implement the per-event synchronization activities described herein. It will be understood that the form of user interface may vary from one remote device to another (e.g., voice prompts and selections via key depressions may be used on a telephone, web page user interface screen for a computer user, etc.); however, in exemplary embodiments the functionality of the user interface remains the same across all remote devices.

Network 106 may comprise a wireless network, a data network, or a combination of the above. Remote device 102 and host system server 104 may communicate with each other utilizing one or a combination of communications technologies including, e.g., satellite or cellular technology, circuit-switched networking, and packet-switched networking, among others. The communications infrastructure utilized for enabling communications for remote device 102 and host system server 104 are well known and will be readily understood by those skilled in the art.

Exemplary embodiments also include a proxy client 108 in communication with remote device 102 via host system server 104 and network 106 via, e.g., a local area network 110. Proxy client 108 may be a network computer operating in a client/server architecture mode with host system server 104 whereby proxy client 108 is a ‘thin client’, or alternatively, proxy client 108 may execute one or more applications stored in memory therein (e.g., an email client application, word processing application, etc). As with remote device 102, proxy client 108 may include a user interface that enables a user to implement the per-event synchronization activities described herein. Proxy client 108 may be operated by a proxy user who shares a relationship with the user of remote device 102 in that the proxy user is authorized by the user of remote device 102 to execute one or more activities on behalf of the remote device 102 user via proxy client 108. For ease of understanding, a user of the remote device 102 user is referred to below as a primary user and the user of proxy client 108 is referred to below as a proxy user.

Alternate embodiments also include a proxy client 114 in communication with the remote device 102 over network 106. Proxy client 114 may comprise a desktop, laptop, or other similar general-purpose computing device known in the art and may be a personal home computer of the user of remote device 102, or may be a small office/home office (SOHO) computer that is associated with remote device 102 user. As with remote device 102, proxy client 114 may include a user interface that enables a user to implement the per-event synchronization activities described herein. Proxy client 114 may be operated by a proxy user who shares a relationship with the user of remote device 102 in that the proxy user is authorized by the user of remote device 102 to execute one or more activities on behalf of the remote device 102 user via proxy client 114.

Each of host system server 104, remote device 102, and proxy client 114 may execute email applications 116a-c, respectively. Also each of host system server 104, remote device 102, and proxy client 114 may also execute applications 118a-c, respectively, for performing the per-event synchronization activities described herein, as well as information manager (IM) applications 120a-c, respectively, for managing the remote device 102 user's calendar, to-do lists, contact information, and other types of data. IM applications 120a-c may comprise a commercial application, such as Microsoft Outlook®, whereby the per-event synchronization applications 118a-c communicate with IM applications 120a-c, respectively, via one or more application programming interfaces (APIs). The per-event synchronization applications 118a-c communicate with the email applications 116a-c, respectively, for implementing the per-event synchronization activities described herein. Alternatively, one or more of IM applications 120a-c, per-event synchronization applications 118a-c, and email applications 116a-c, respectively, may comprise a single application provides both personal information management functions and per-event synchronization, as well as email functions.

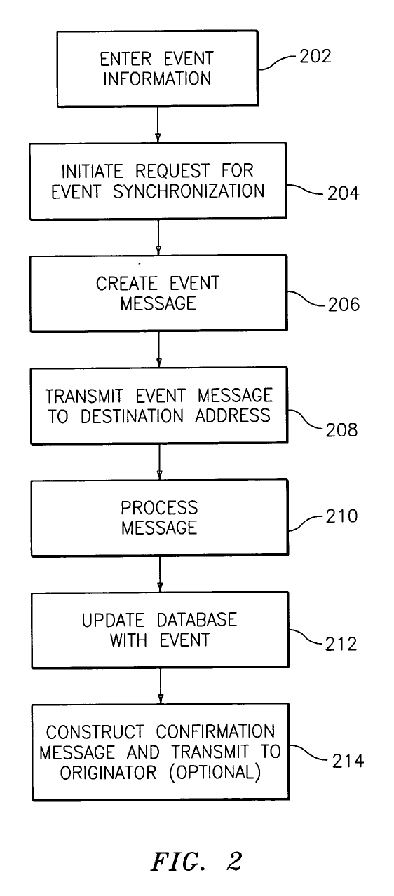

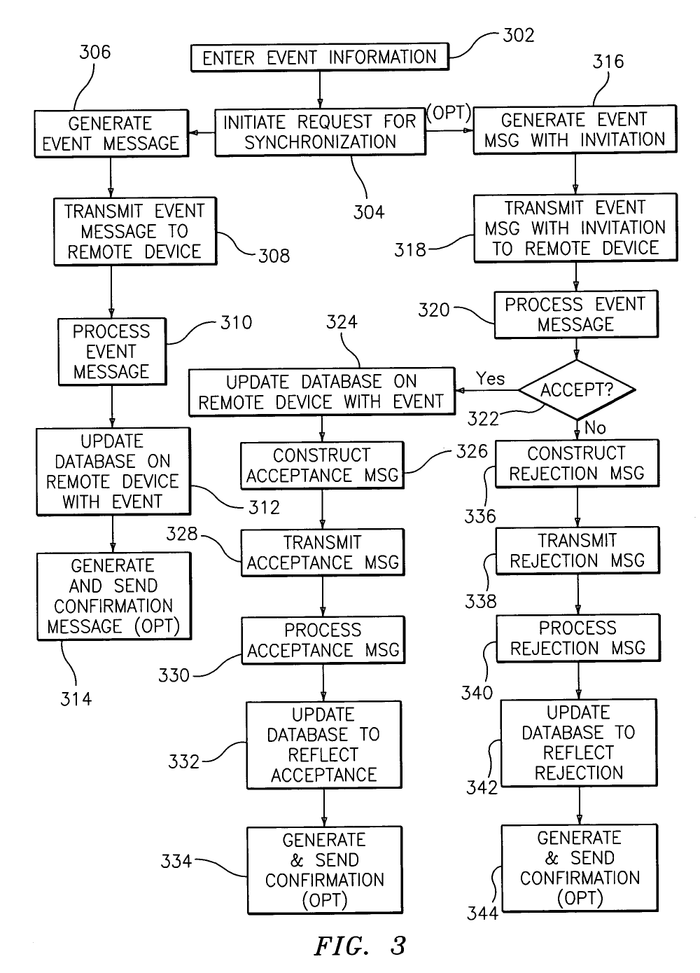

The synchronization activities performed via the per-event synchronization application may be initiated remotely (e.g., via remote device 102) or may be initiated by a proxy client associated with the remote device. If the request to synchronize is initiated at the remote device, it is assumed that the event information entered into the IM application 120b is a desired entry and that the synchronization of the proxy client 108 or 114 should be completed at the time of the request for synchronization. There may be instances in which the event information entered into an IM application may not be assumed to be desired. For example, a proxy user at one of client systems 108, 114 may be tentatively scheduling an appointment for the primary user of an IM application and the primary user may desire to review and either accept or decline the tentative entry before the synchronization operation occurs. The per-event synchronization system manages both of these scenarios, the first being described in FIG. 2 and the latter in FIG. 3.

While the means of transmitting the event information over the network 106 are described herein as ‘email’ messages, it will be understood by those skilled in the art that other forms of transmission may be utilized such as short messaging service (SMS), etc.

An exemplary process for performing remotely initiated synchronization of an event will now be described with respect to FIG. 2. At step 202, a remote user enters event information into the IM application 120b on remote device 102. The event may be the addition of a new contact, a change to or deletion of a contact, a new appointment, a change to or a deletion of an existing appointment, a new to-do item or reminder, or a change to or deletion of an existing to-do item or reminder, to name a few. At step 204, the user initiates a request for event synchronization. This request may be implicit, such as by selecting ‘enter’ or ‘save’ via the input controls 105 of remote device 102, or this request may be explicit, such as a response to a prompt by remote device 102 to initiate a request for synchronization of the event (e.g., via display 103). If the request is initiated implicitly by a ‘save’ command, the event information is stored locally on remote device 102. If the request is explicit, the event information may be saved locally in memory of the remote device 102 during the request process or shortly after completion of the request process. The per-event synchronization application 118b timestamps the event information and assigns a unique identifier to the event information.

At step 206, the per-event synchronization application 118b creates an event message. The event message may include an address (e.g., an email address or a static Internet Protocol (IP) address) of the destination client (host system server 104/proxy client 108, or proxy client 114), the timestamp, the unique identifier, and the event information content (e.g., new contact information). For purposes of illustration, the destination address is described herein to be the host system server 104/proxy client 108; however, the functionality described with respect to FIG. 2 applies equally to proxy client 114 as well.

The event message is transmitted over network 106 via email application 116b to its destination (e.g., host system server 104) at step 208. The email application 116a on host system server 104 executing on proxy client 114 ‘unwraps’ the event message and processes the event message at step 210. The processing includes reading the contents to determine whether the event message relates to an IM event synchronization as distinguished from other messages such as standard email messages. The processing also identifies what action is to be executed in the synchronization (e.g., add new contact, change appointment time, etc.) Once processed, the IM application 120a updates the event information from the event message in data storage 112 at step 210. Optionally, a confirmation of the update may be constructed by the per-event synchronization application 118a and sent by email application 116a the remote device 102 at step 212. The confirmation serves to notify the remote device 102 user that the update has been successfully completed at step 214.

In addition to initiating a synchronization event by the remote device 102, an event synchronization may also be initiated by one or both of proxy clients 108 and 114 as will now be described in the flow diagram of FIG. 3. For purposes of illustration, the destination address is described herein to be the host system server 104/proxy client 108; however, the functionality described with respect to FIG. 2 applies equally to proxy client 114 as well.

An authorized representative referred to as “proxy user” of the remote device 102 user (e.g., assistant or secretary at proxy client 108) logs into the IM application 120a and enters event information at step 302. For example, a secretary desires to schedule a meeting for the user of remote device 102 and enters the meeting information (e.g., date, place, time, etc.) into the IM application 120a via the host system server 104 and LAN 110. The event information may be saved in storage device 112. A request to initiate synchronization of the event information is initiated at step 304. As described above in FIG. 2, this request may be implicit or explicit.

In one embodiment, the per-event synchronization application 118a constructs an event message and attaches the address (e.g., email address or IP address) of remote device 102 at step 306 in a similar manner to that described above in FIG. 2. The message is transmitted via email application 116a to remote device 102 at step 308. The email application 116b on remote device 102 unwraps the event message and the per-event synchronization application 118b processes the message at step 310. Again, this processing may be similar to that described above in FIG. 2. The IM application 120b updates the memory in remote device 102 at step 312 to reflect the event information. Optionally, the per-event synchronization application 118b may construct a confirmation message as described above in FIG. 2 and transmit the confirmation message back to the host system server 104 via email application 116b at step 314.

In other embodiments, following the initiation of the request for synchronization described above in step 304, the per-event synchronization application 118a constructs an event message as described above and includes an ‘invitation’ to accept the event or reject the event at step 316. The event message is transmitted via email application 116a to remote device 102 at step 318. The message is unwrapped by the email application 116b on remote device 102 and processed by the per-event synchronization application 118b at step 320 as described above in FIG. 2.

At step 322, the per-event synchronization application 118b prompts the remote device 102 user to either accept or decline the event via, e.g., display 103 and control buttons 105. If the user accepts the event at step 322, the IM application 120b updates the event information in the memory of remote device 102 at step 324. The per-event synchronization application 118b then constructs an acceptance message at step 326 and transmits the acceptance message to the host system server 104 at step 328. The acceptance message may be constructed in a similar manner as that described above with respect to the event message. The acceptance message is unwrapped by the email application 116a and processed by the per-event synchronization application 118a at step 330. The IM application 120a updates the storage device 112 to reflect the acceptance at step 332. Optionally, a confirmation of the acceptance described in step 332 may be generated by the per-event synchronization application 118a and transmitted to remote device 102 via email application 116a at step 334.

If on the other hand, the remote device user does not accept the event at step 322, the per-event synchronization application 118b constructs a decline message at step 336 and transmits the decline message to the host system server 104 via email application 116b at step 338. The email application 116a at host system server 104 unwraps the message and the per-event synchronization application 118a processes the decline message at step 340. The IM application 120a updates the storage device 112 to cancel the event at step 342. Optionally, a confirmation of the cancellation may be generated by the per-event synchronization application 118a and transmitted to remote device 102 via email application 116a at step 344.

The per-event synchronization process contemplates performing acceptance and rejection activities via alternate means. In alternate embodiments, for example, the per-event synchronization application 118a or 118c may save the event information locally in storage device 112 or in internal memory of proxy client 114 along with a flag that indicates that the event information entered is tentative and pending acceptance by the remote device 102 user. In this manner, the receipt of an acceptance message may prompt the removal of the ‘tentative flag’ from the event information or the deletion of the event information from storage upon receipt of a decline message from the remote device 102 user.

As described above, the per-event synchronization system enables synchronization of entries made in an information management application on a per-event basis. According to exemplary embodiments, the synchronization occurs at the time each of the entries are made so that the devices executing the information management applications are updated in real time or near real time enabling a user to maintain the most up-to-date information at any given time. Because the synchronization occurs on a per-event basis, small amounts of information may be quickly and easily transferred between devices, resulting in the most current, up-to-date information. Also, as only the information relating to the event itself is processed by the information management application, the time and resources devoted to analyzing the event data are reduced. The synchronization process does not require that the devices to be synchronized be co-located so an individual can synchronize his/her devices at any time.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for performing device synchronization, comprising:
initiating a synchronization operation in response to an entry of event information in an information management application executing on a device, the device associated with at least one other device, the other device executing an information management application;
assigning a unique identifier to the event information;
generating an event message, the event message including the unique identifier, the event information, and a destination address associated with the other device; and
transmitting the event message to the destination address;
wherein, upon receiving the event message, the other device updates its information management application with the event information via the unique identifier resulting in per-event synchronization of the device and the other device.

2. The method of claim 1, wherein the event information includes at least one of:
new contact information;
a change in existing contact information;
a deletion of a contact;
a new appointment;
a change in an existing appointment;
a deletion of an appointment;
a reminder;
a to-do item; and
a data item.

3. The method of claim 1, wherein the entry of event information and updating the other information management application occur in near real time.

4. The method of claim 1, further comprising receiving confirmation of a successfully completed synchronization at the device.

5. A method for performing device synchronization, comprising:
receiving an event message at a device, the event message including event information entered in an information management application executing on at least one other device;
prompting a user of the device to accept or reject the event information;
receiving a response to the prompting;
generating an acceptance message or decline message in response the receiving; and
transmitting the acceptance message or decline message to the other device;
wherein the other device updates the information management application with the event information to reflect the acceptance message or decline message resulting in a per-event synchronization of the device and the other device.

6. The method of claim 5, wherein the event information includes at least one of:
new contact information;
a change in existing contact information;
a deletion of a contact;
a new appointment;
a change in an existing appointment;
a deletion of an appointment;
a reminder;
a to-do item; and
a data item.

7. The method of claim 5, wherein the event information entered in an information management application and updating the information management application with the event information occur in near real time.

8. The method of claim 1, further comprising receiving confirmation of a successfully completed synchronization at the device.

9. An apparatus for performing device synchronization, comprising:
a processor;
a memory;
an information management application executing on the processor, the information management application receiving an entry of event information and storing the event information in the memory;
a per-event synchronization application executing on the processor, the per-event synchronization application in communication with the information management application; wherein, in response to the receiving an entry of event information, the per-event synchronization application initiates a synchronization operation, assigns a unique identifier to the event information, and generates an event message, the event message including the unique identifier, the event information, and a destination address associated with a device; and
a messaging application executing on the processor, the messaging application in communication with the per-event synchronization application; wherein, the messaging application transmits the event message to the destination address.

10. The apparatus of claim 9, wherein the event information includes at least one of:
new contact information;
a change in existing contact information;
a deletion of a contact;
a new appointment;
a change in an existing appointment;
a deletion of an appointment;
a reminder;
a to-do item; and
a data item.

11. The apparatus of claim 9, wherein an information management application executing on the device is updated with the event information; and wherein further updating the information management application and the entry of event information occur in near real time.

12. The apparatus of claim 9, further comprising a confirmation message operable for providing notification that a synchronization operation has been successfully completed.

13. An apparatus for providing device synchronization, the apparatus comprising:
a processor;
a memory;
an information management application executing on the processor, the information management application receiving an event message including event information, the event information previously entered in an information management application executing on a device;
a per-event synchronization application executing on the processor, the per-event synchronization application in communication with the information management application; wherein, in response to the receiving an event message, the per-event synchronization application prompts a user to accept or reject the event information, receives a response to the prompts, and generates an acceptance message or decline message in response to receiving the response;
a messaging application executing on the processor, the messaging application in communication with the per-event synchronization application; wherein, the messaging application transmits the event message to the destination address.

14. The apparatus of claim 13, wherein the event information includes at least one of:
new contact information;
a change in existing contact information;
a deletion of a contact;
a new appointment;
a change in an existing appointment;
a deletion of an appointment;
a reminder;
a to-do item; and
a data item.

15. The apparatus of claim 13, wherein an information management application executing on the device is updated with the event information to reflect the acceptance message or decline message; and wherein further, updating the information management application and the entry of event information occur in near real time.

16. The apparatus of claim 13, further comprising a confirmation message operable for providing notification that a synchronization operation has been successfully completed.

17. A computer program product comprising a storage medium readable by a processing circuit and storing instructions for execution by the processing circuit for facilitating a method comprising:
initiating a synchronization operation in response to an entry of event information in an information management application executing on a device, the device associated with at least one other device, the other device executing another information management application;
assigning a unique identifier to the event information;
generating an event message, the event message including the unique identifier, the event information, and a destination address associated with the other device; and
transmitting the event message to the destination address;
wherein, upon receiving the event message, the other device updates the other information management application with the event information via the unique identifier resulting in per-event synchronization of the device and the other device.

18. The computer program product of claim 17, wherein the event information includes at least one of:
new contact information;
a change in existing contact information;
a deletion of a contact;
a new appointment;
a change in an existing appointment;
a deletion of an appointment;
a reminder;
a to-do item; and
a data item.

19. A computer program product comprising a storage medium readable by a processing circuit and storing instructions for execution by the processing circuit for facilitating a method comprising:
receiving an event message at a device, the event message including event information entered in an information management application executing on at least one other device;
prompting a user of the device to accept or reject the event information;
receiving a response to the prompting;
generating an acceptance message or decline message in response the receiving; and
transmitting the acceptance message or decline message to the other device;
wherein the other device updates the information management application with the event information to reflect the acceptance message or decline message resulting in a per-event synchronization of the device and the other device.

20. The computer program product of claim 19, wherein the event information includes at least one of:
new contact information;
a change in existing contact information;
a deletion of a contact;
a new appointment;
a change in an existing appointment;
a deletion of an appointment;
a reminder;
a to-do item; and
a data item.
